(19) United States
(12) Patent Application Publication
(10) Pub. No.: US 2016/0290377 A1
(43) Pub. Date: Oct. 6, 2016

(54) TELESCOPING JOINT

(71) Applicant: Koncept Technologies Inc., Monrovia, CA (US)

(72) Inventors: Hon Kit Peter Ng, Hong Kong (CN); Kenneth Yat Chung Ng, Alhambra, CA (US); Edmund Yat Kwong Ng, Pasadena, CA (US)

(73) Assignee: Koncept Technologies Inc., Monrovia, CA (US)

(21) Appl. No.: 14/679,950

(22) Filed: Apr. 6, 2015

(51) Int. Cl. F16B 7/14

(52) U.S. Cl. CPC F16B 7/14

(57) ABSTRACT

An adjustable structure is described herein according to various embodiments, including an inner tube member and an outer tube member. The inner tube member and the outer tube member are configured to move in at least one of a telescoping direction or a rotation direction with respect to one another. The adjustable structure further includes a first frictional element between the inner tube member and the outer tube member. The first frictional element provides friction in the telescoping direction. Furthermore, the adjustable structure includes a second frictional element between the inner tube member and the outer tube member. The second frictional element provides friction in the rotational direction.

### BACKGROUND

1. Field

The present disclosure relate to structures for providing frictional forces between two members configured for movement with respect to each other, and in particular embodiments, to at least one bushing structure or joint configured to exert frictional forces between the two members configured to engage in telescoping and/or rotational movements with respect to each other. Particular embodiments relate to supporting structures having one or more of such bushing structures or joints for supporting light-emitting elements or other electronic or operational devices, and lamps or other electronic or operational devices that include such supporting structures.

2. Background

Lamp configurations (e.g., a desk lamp, floor lamp, wall light, slim adjustable LED lamp, or the like) can be configured with telescoping tube members that support light-emitting elements, where the telescoping tube members allow for adjustable movement (e.g., vertical up or down movements) to adjust the position of the light-emitting elements. Such telescoping tube configurations can allow for linear, telescoping movement in the direction of the axis of the tubes. However, it can also be beneficial to allow rotational adjustment of the light-emitting elements, relative to the axis of the tubes. Lamp configurations that allow for both linear (telescoping) adjustment of the position of the light-emitting elements and rotational adjustments of the position of the light-emitting elements can provide improved flexibility in positioning of the light-emitting elements for better illumination of a desired object or region.

A head portion containing (or otherwise including) the light-emitting elements may be connected or otherwise linked to one of the telescoping tube members. However, the head portion may have a mass (or weight) that can cause the head portion to droop due to gravity, if not sufficiently supported. Accordingly, where the head portion is supported by a support structure having a telescoping tube configuration, the telescoping tubes may be configured to resist rotational motion, to inhibit the head portion from moving (or drooping) by gravity.

### SUMMARY OF THE DISCLOSURE

An adjustable structure (e.g., a flexible adjustable desk lamp) may include two tube members, an inner tube member and an outer tube member arranged along a common axis, and configured for telescoping movement in the direction of the axis and rotational movement around the axis with respect to each other. For example, the inner tube member may located within the outer tube and may be pulled or pushed (or otherwise moved) relative to the outer tube member in a telescoping movement (linearly, along an axial direction of the tube members). The inner tube member may also be rotated with respect to the outer tube member in a rotational movement about the common axis of the tube members. A first frictional element provides a first frictional force (e.g., a frictional force against linear, telescoping motion) to hold and maintain a linear position of the tube members against gravity after the tube members are moved relative to each other in a linear, telescoping direction. A second frictional element provides a second frictional force (e.g., a frictional force against rotational motion) to hold and maintain a rotational position of the tube members against gravity, after the tube members are moved relative to each other in a rotational direction.

In various embodiments described herein, the first frictional element and the second frictional elements are separate components of an adjustable structure. The first frictional element may include a first bushing calibrated or configured to be calibrated to exert an appropriate amount of the first frictional force against at least one of the tube members. The first frictional element may exert insignificant or no second frictional force against at least one of the tube members. The second frictional element may include a second bushing calibrated or configured to be calibrated to exert an appropriate amount of the second frictional force against at least one of the tube members. The second frictional element may exert insignificant or no first frictional force against at least one of the tube members. Accordingly, the first frictional force and the second frictional force may be independently adjusted by adjusting either the first frictional element or the second frictional element. In other embodiments, the first and second frictional elements may be configured in a unitary or joined structure.

The first and second frictional elements may be provided between the inner tube member and the outer tube member. In particular, at least a portion (e.g., surface contact portions) of the first and/or the second frictional element may contact the inner tube member, the outer tube member, or both.

Accordingly, particular embodiments provide frictional forces for preventing drooping and collapsing of the adjustable structure (with respect to the inner tube member and the outer tube member) while allowing the inner tube member and the outer tube member to be adjusted (e.g., moved in the linear, telescoping and/or rotational direction) smoothly. In embodiments in which the first frictional element and the second frictional element may be adjusted independent of one another, the appropriate amount of frictional force (e.g., the first frictional force or the second frictional force) may be provided in either the telescoping or rotational direction to allow manual adjustment of the relative linear or rotational position of the tube members, and to maintain the tube members in the adjusted position. In this manner, the first and second frictional forces may be independently selected so as to allow a user to easy make manual adjustments to the relative positions of the tube members in the linear and/or rotational directions, where such adjustments are frictionally maintained, without imparting frictional forces in the other of the linear and/or rotational directions so great as to interfere with or inhibit manual adjustment of the tube members in that other direction.

In some embodiments, an adjustable structure described herein includes an inner tube member and an outer tube member. The inner tube member and the outer tube member are configured to move in at least one of a linear, telescoping direction or a rotation direction with respect to one another, relative to a common axis of the inner and outer tube members. The adjustable structure further includes a first frictional element between the inner tube member and the outer tube member. The first frictional element provides friction in the telescoping direction. Furthermore, the adjustable structure includes a second frictional element between the inner tube member and the outer tube member. The second frictional element provides friction in the rotational direction.

In some embodiments, the first friction component is arranged between an inner tube member and an outer tube member. The first friction component includes at least one first frictional element. Each first frictional element includes an annular body having an inner surface. In particular embodiments, an inner diameter defined by the inner surface of the annular body is greater than an outer diameter of the inner tube member. In such embodiments, each first frictional element also includes a bearing surface arranged to frictionally contact an inner wall of the outer tube member. The first friction component also includes a groove configured to contain the at least one frictional element.

In some embodiments, the second friction component is arranged between an inner tube member and an outer tube member. The second friction component includes at least one second frictional element. Each second frictional element includes an annular body having an inner surface. In particular embodiments, an inner diameter defined by the inner surface of the annular body is greater than an outer diameter of the inner tube member. In such embodiments, each second frictional element also includes a bearing surface arranged to frictionally contact an inner wall of the outer tube member. Furthermore, in such embodiments, each second frictional element includes a tab configured to engage a channel of the inner tube member, to prevent rotation of the second frictional element relative to the inner tube member. The channel is arranged along a longitudinal dimension of the inner tube member.

### BRIEF DESCRIPTION OF THE DRAWINGS

The details of one or more implementations are set forth in the accompanying drawings and the description below. Other features, aspects, and advantages of the disclosure will become apparent from the description, the drawings, and the claims, in which:

FIG. 1 is a perspective view of an example of an adjustable structure according to various embodiments.

FIG. 2A is a side view of the adjustable structure in a first telescoping state according to various embodiments.

FIG. 2B is yet another side view of the adjustable structure in a second telescoping state according to various embodiments.

FIG. 3A is a top view of the adjustable structure in a first rotational state according to various embodiments.

FIG. 3B is yet another top view of the adjustable structure in a second rotational state according to various embodiments.

FIG. 4 is a cross-section view of the adjustable structure showing a system including a first frictional element and a second frictional element according to various embodiments.

FIG. 5 is a perspective view of an embodiment of the first frictional element.

FIG. 6 is a cross-section view of an embodiment of a telescoping friction component arranged in the adjustable structure having the inner tube member and the outer tube member.

FIG. 7A is a perspective view of an embodiment of a second frictional element.

FIG. 7B is a perspective view of another embodiment of the second frictional element.

FIG. 8 is a perspective view of an embodiment of the second frictional element arranged in the adjustable structure having the inner tube member and the outer tube member.

FIG. 9 is a cross-section view of an embodiment of a rotational friction component arranged in the adjustable structure having the inner tube member and the outer tube member.

### DETAILED DESCRIPTION OF THE EMBODIMENTS

In the following description of preferred embodiments, reference is made to the accompanying drawings which form a part hereof and in which are shown by way of illustration specific embodiments in which the invention may be practiced. It is to be understood that other embodiments may be utilized and structural changes may be made without departing from the scope of the preferred embodiments of the present disclosure.

Referring generally to the features, embodiments described herein relate to an adjustable structure (such as, but not limited to, a flexible adjustable desk lamp) having a telescopic arm structure. The telescopic arm structure may include at least two members configured for telescoping and rotational movements with respect to each other. Examples of the two members include, but are not limited to, an inner tube member and an outer tube member arranged coaxially, with the inner tube member at least partially within the outer tube member.

The first component and the second component may be concentric tubular components having a common longitudinal axis. As used herein, a telescoping movement may refer to both sliding (in the linear direction of the axis of the tube members) by a first component (e.g., the inner tube member) into a second component (e.g., the outer tube member) and sliding (in the linear direction of the axis of the tube members) by the first component outside from the second component. A rotational movement may refer to rotating the first component with respect to the second component around the axis of the tube members.

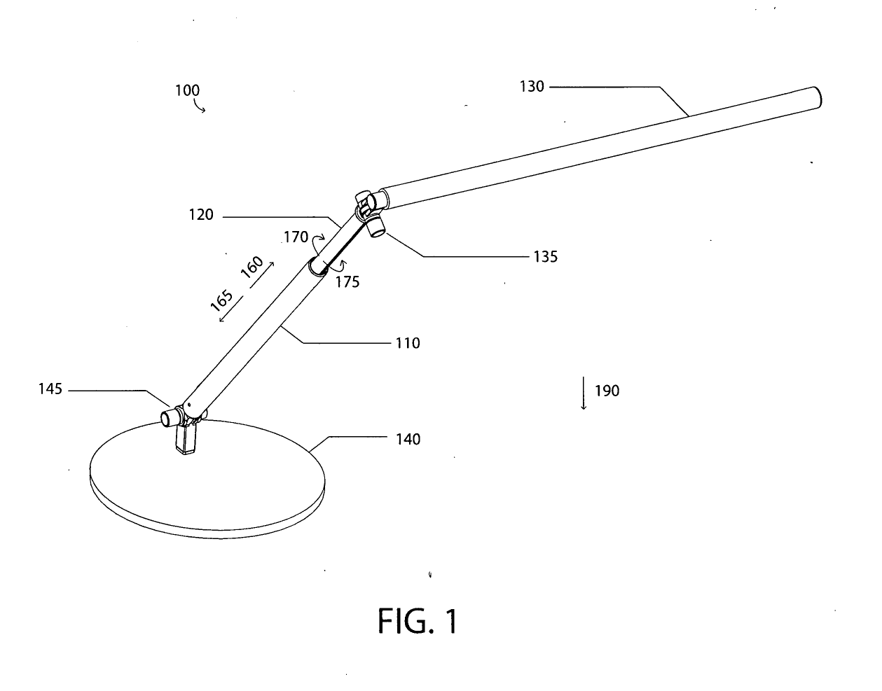

FIG. 1 is a perspective view of an example of an adjustable structure 100 according to various embodiments. Referring to FIG. 1, the adjustable structure 100 may be shown as a flexible adjustable desk lamp. While the adjustable structure 100 may be included in various embodiments in an adjustable desk lamp, in other embodiments the adjustable structure 100 may be included in another suitable support structure containing concentric adjustable parts (e.g., an outer tube member 110 and an inner tube member 120) configured for telescoping and/or rotational movement with respect to each other. Other examples of the adjustable structure 100 may include, but not limited to, support structures for supporting tools, weapons, work-pieces, or the like. In embodiments in which the adjustable structure 100 supports a light-emitting element, the adjustable structure may include various types of desk lamps, floor lamps, wall-mounted lamps, slim adjustable (light emitting diode) LED lamps, and the like.

The adjustable structure 100 may include at least a head portion 130, a first joint 135, an inner tube member 120, an outer tube member 110, a second joint 145, and a base portion 140. The head portion 130 may include at least one light-emitting element. The light-emitting element may include suitable light sources including, but not limited to, light bulbs, LEDs, other electricity-powered light sources, a combination thereof, and/or the like. The head portion 130 may be connected to the inner tube member 120 through the first joint 135. The first joint 135 may allow the head portion 130 and the inner tube member 120 to move with respect to each other in any or all suitable directions about the first joint 135. Given that the ability to move about the first joint 135, the position of the head portion 130 with respect to the rest of the adjustable structure 100 may shift the center of mass of the adjustable structure 100 and cause telescopic collapsing (e.g., the inner tube member 120 sliding into the outer tube member 110 due to gravity 190) or drooping of the head portion 130 due to gravity 190.

The base portion 140 may be a base for stabilizing the rest of the adjustable structure 100 on a surface (e.g., a table, desk, floor, or other types of surfaces). The base portion 140 may be of considerable weight to prevent tilting or falling of the adjustable structure 100. The base portion 140 may be connected to the outer tube member 110 through the second joint 145. The second joint 145 may allow the outer tube member 110 to move with respect to the base portion 140 in any or all suitable directions about the second joint 145.

Each of the first joint 135 and the second joint 145 may be suitable movable mechanical or electromechanical joints such as, but not limited to, a knuckle joint, ball joint, pivot joint, saddle joint, plane joint, hinge joint, ellipsoid joint, a combination thereof, and/or the like. In particular embodiments, each of the first joint 135 and the second joint 145 may be a joint structure described with respect to either U.S. Pat. No. 8,714,779 (filed Mar. 21, 2013) or U.S. patent application Ser. No. 13/565,686 (filed Aug. 2, 2012), both incorporated herein by reference in their entirety.

In various embodiments, the inner tube member 120 and the outer tube member 110 may be concentric tubular members. For example, the outer tube member 110 may be an outer sleeve of the inner tube member 120. One of ordinary skill in the art would appreciate that, while the inner tube member 120 and the outer tube member 110 are shown to be cylindrical tubes, the inner tube member 120 and the outer tube member 110 may be of other suitable shapes (such as, but not limited to, rectangular tubes, square tubes, oval tubes, or the like) suitable for telescoping and rotational movement with respect to one another. Each of the inner tube member 120 and the outer tube member 110 may be made of any suitably rigid material, such as, but not limited to, metal, plastic, ceramic, wood, composite material, or the like.

In some embodiments, the inner tube member 120 may be movable (moved or adjusted by a user) with respect to the outer tube member 110 in telescoping directions (e.g., an outward telescoping direction 160 and/or inward telescoping direction 165). The inner tube member 120 may be movable (moved or adjusted by a user) with respect to the outer tube member 110 in rotational directions (e.g., a clockwise direction 170 and/or counterclockwise direction 175). The inner tube member 120 may be moved by moving a portion of the inner tube member 120, the first joint 135, and/or the head portion 130 by the user. Given that the outer tube member 110 may be movably attached to the base portion 140 (which may remain stationary on the surface when the adjustable structure 100 is adjusted by the user) by the second joint 145, the outer tube member 110 may not be moved with respect to the inner tube member 120. Rather, the inner tube member 120 may be configured to be moved with respect to the outer tube member 110.

In other embodiments, the inner tube member 120 (the component inside of the outer tube member 110) may be connected to the base portion 140 via the second joint 145 while the outer tube member 110 may be connected to the head portion 130 by the first joint 135. In such embodiments, the outer tube member 110 (instead of the inner tube member 120) may be movable in the telescoping directions and the rotational directions by moving a portion of the outer tube member 110, the first joint 135, and/or the head portion 130 by the user.

In addition, the adjustable structure 100 may include at least one frictional element configured for providing frictional forces between the inner tube member 120 and the outer tube member 110 to prevent collapsing and dropping of the adjustable structure 100 due to gravitational force 190. For example, the force 190 of gravity may act on the adjustable structure 100 in the inward telescoping direction 165. Thus, a frictional force against movement in the outward telescoping direction 160 may be provided by the at least one frictional element to hold the adjustable structure 100 in place, to counter the force 190 of gravity. Gravity 190 may also act on the adjustable structure 100 in the clockwise direction 170 or counterclockwise direction 175, depending on the orientation of the adjustable structure 100. Thus, a frictional force against movement in the counterclockwise direction 175 or clockwise direction 170 (opposite to the force 190 due to gravity) may be provided by the at least one frictional element to hold the adjustable structure 100 in place, to counter the force 190 of gravity.

In particular embodiments, the at least one frictional element may include two or more frictional elements. A first frictional element may be configured to provide frictional force against movements in the telescoping directions. A second frictional element may be configured to provide frictional force against movement in the rotational directions. In some embodiments, the first frictional element and the second frictional element may be a same component (i.e., physically adjusted to one another or configured to move together). In other embodiments, the first frictional element and the second frictional element may be separate components (i.e., physically separated and/or provided at different locations). The first frictional element and the second frictional element may be provided between the inner tube member 120 and the outer tube member 110.

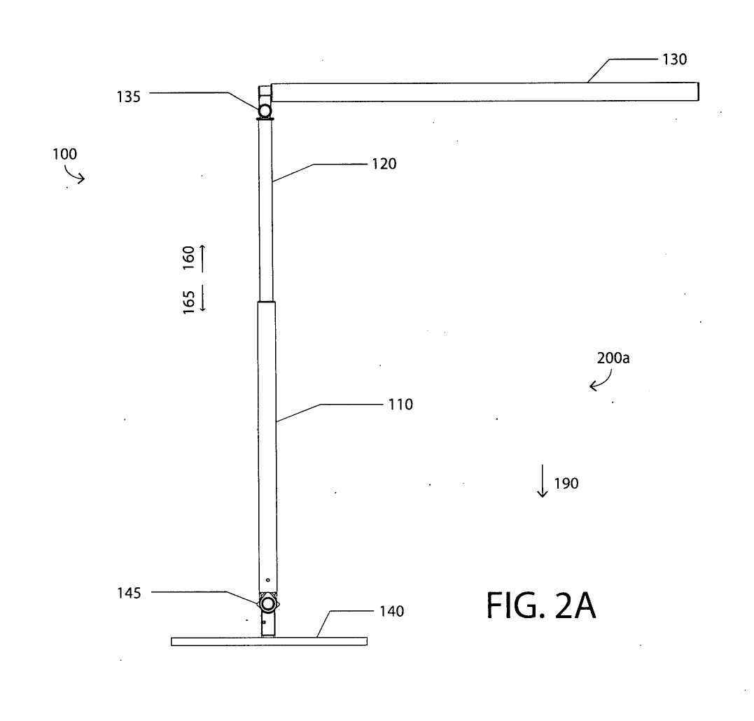

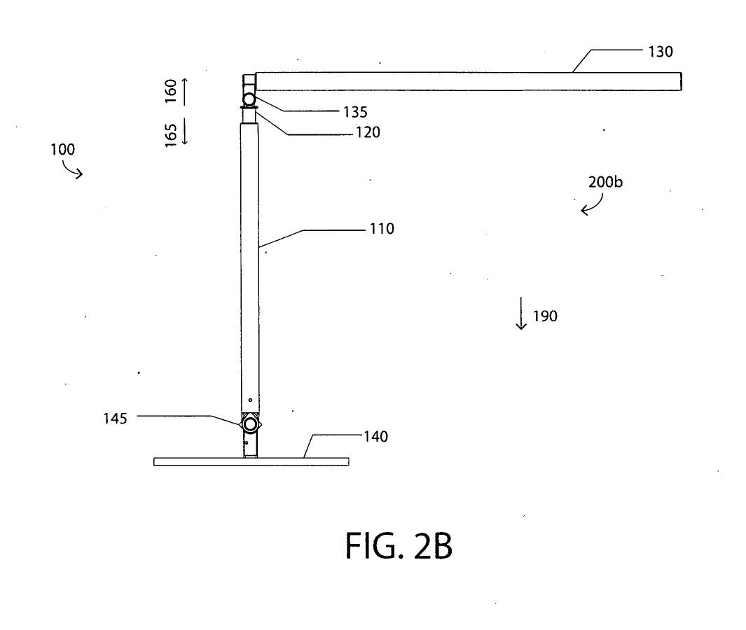

FIG. 2A is a side view of the adjustable structure 100 in a first telescoping state 200a according to various embodiments. FIG. 2B is yet another side view of the adjustable structure 100 in a second telescoping state 200b according to various embodiments. Referring to FIGS. 1-2B, the inner tube member 120 and the outer tube member 110 may be configured to move in the telescoping directions (e.g., the outward telescoping direction 160 and/or inward telescoping direction 165) with respect to one another. For example, the adjustable structure 100 may be movable from the first telescoping state 200a to the second telescoping state 200b in the inward telescoping direction 165. The adjustable structure 100 may also be movable from the second telescoping state 200b to the first telescoping state 200a in the outward telescoping direction 160. A suitable frictional element (e.g., the first frictional element) may provide friction to maintain the adjustable structure 100 in any position including and between the first and second telescoping states (and inhibit linear movement of the inner and outer tube members from that position due to gravity) without adding significant or any frictional force against movement in a rotational direction.

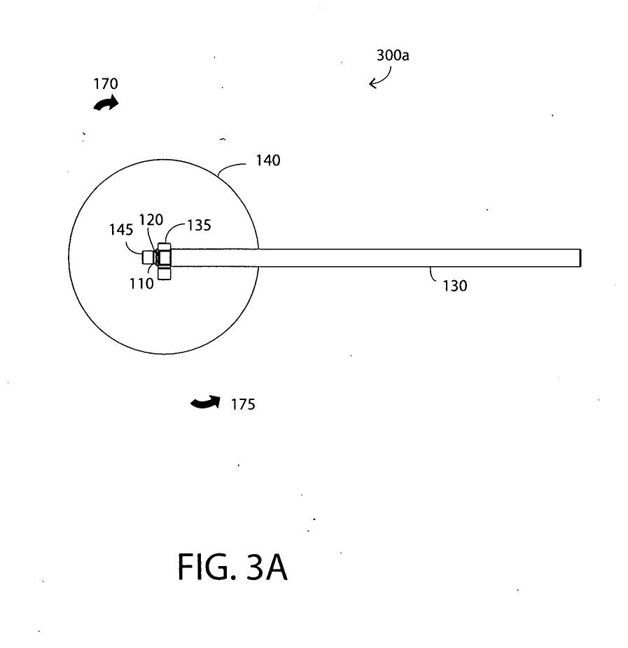

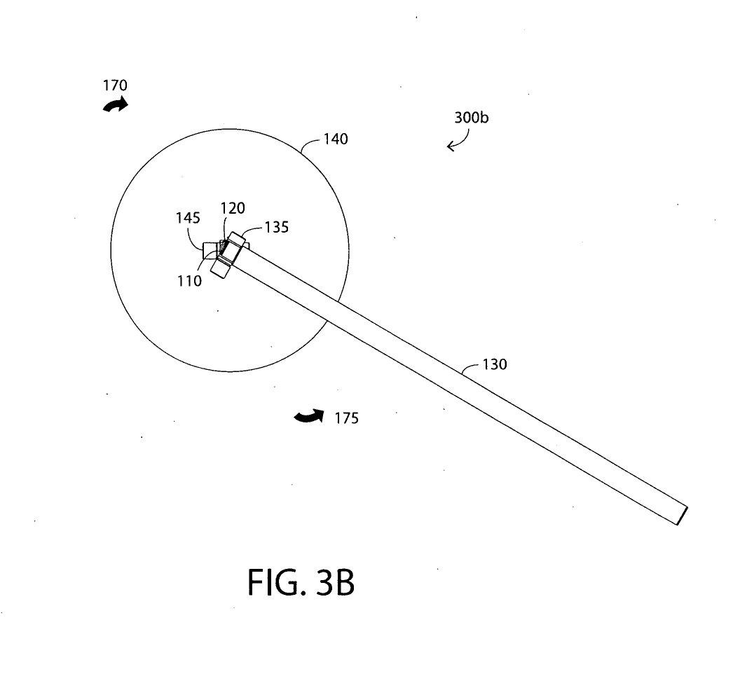

FIG. 3A is a top view of the adjustable structure 100 in a first rotational state 300a according to various embodiments. FIG. 3B is yet another top view of the adjustable structure 100 in a second rotational state 300b according to various embodiments. Referring to FIGS. 1-3B, the inner tube member 120 and the outer tube member 110 may be configured to move in the rotational directions (e.g., the clockwise direction 170 and/or counterclockwise direction 175) with respect to one another. For example, the adjustable structure 100 may be movable from the first rotational state 300a to the second rotational state 300b in the clockwise direction 170. The adjustable structure 100 may also be movable from the second rotational state 300b to the first rotational state 300a in the counterclockwise direction 175. A suitable frictional element (e.g., the second frictional element) may provide friction to maintain the adjustable structure 100 in any position including and between the first and second rotational states (and inhibit relative rotational movement of the inner and outer tube members from that position due to gravity) without adding significant or any frictional force against relative movement of the inner and outer tube members in the rotational directions.

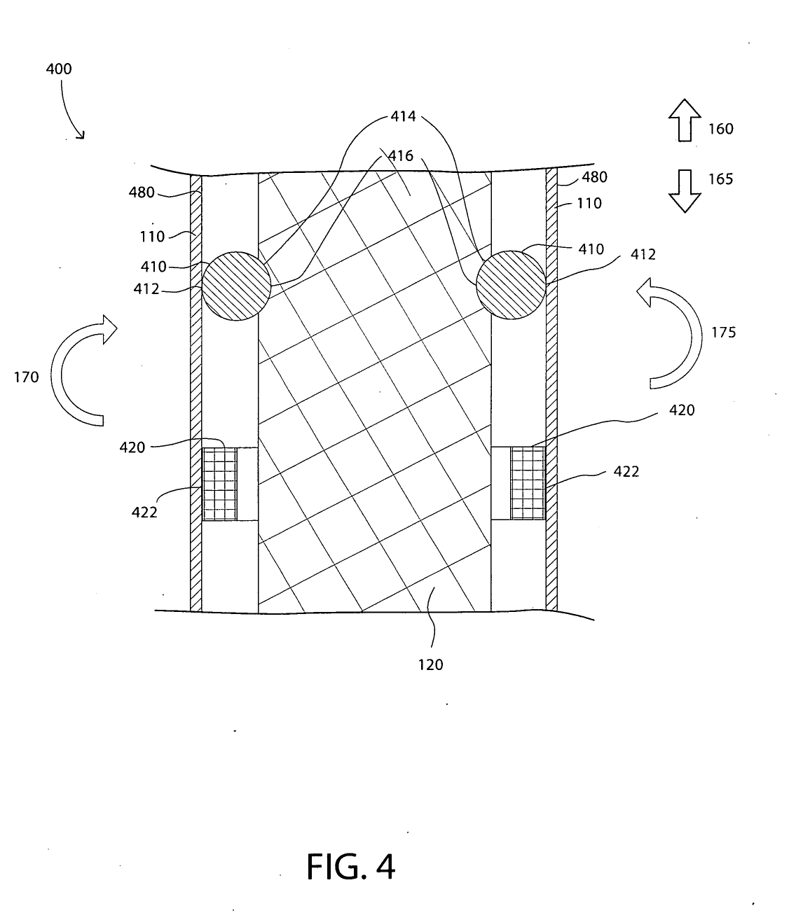

FIG. 4 is a cross-section view of the adjustable structure 100 showing a system 400 including a first frictional element 410 and a second frictional element 420 according to various embodiments. Referring to FIGS. 1-4, each of the first frictional element 410 and the second frictional element 420 may be located between the inner tube member 120 and the outer tube member 110.

The first frictional element 410 may be configured to exert frictional force against relative movement of the inner and outer tube members 120 and 110 in the telescoping directions. In particular, the first frictional element 410 may hold the adjustable structure 100 (e.g., the relative positions of the inner tube member 120 and the outer tube member 110) in place by exerting the first frictional force against gravity 190 or at least a component thereof. In other words, the first frictional element 410 may exert an appropriate amount of frictional force between the inner tube member 120 and the outer tube member 110, to prevent the collapsing of the inner tube member 120 due to gravity 190.

In some embodiments, the first frictional element 410 may be a bushing (of any suitable shape, including an annular shape) around the inner tube member 120. In other embodiments, the first frictional element 410 may be a C-shaped or partially annular member in the manner described. The first frictional element 410 may have a first bearing surface 412 contacting an inner wall 480 of the outer tube member 110. The first bearing surface 412 may provide a frictional force with the inner wall 480 of the outer tube member 110 sufficient to prevent linear relative movement of the inner tube member 120 with respect to the outer tube member 110 due to the force of gravity. The first frictional element 410 may have a receiving surface 414 contacting or proximal to walls of a groove 416 of the inner tube member 120. The groove 416 may be a concave portion on the outer surface of the inner tube member 120. The groove 416 may be provided around an external surface of the inner tube member 120. The groove 416 may hold the first frictional element 410 in place along the telescoping directions. The first frictional element 410 may be made of suitable material such as, but not limited to, metal, plastic, ceramic, wood, composite material, or the like.

In particular embodiments, the first frictional element 410 is held within the groove 416 and does not move along the linear axial direction (telescoping directions) with respect to the inner tube member 120. The first frictional element 410 (at the first bearing surface 412) moves with respect to the outer tube member 110 along the telescoping directions, providing the frictional force between the first bearing surface 412 and the inner wall 480 of the outer tube member 110.

In some embodiments, when a rotational force is applied to the inner tube member 120 (or the outer tube member 110), the first frictional element 410 may rotate with respect to the inner tube member 120. In particular embodiments, first frictional element 410 may freely rotate with respect to the inner tube member 120. For example, the inner diameter of the first frictional element 410 may be slightly greater than the outer diameter of the inner surface of the groove 416. Accordingly, the first frictional element 410 may provide minimal or no rotational frictional force that would inhibit movement of the first frictional element 410 in the rotational directions.

In some embodiments, the first frictional element 410 may rotate with the outer tube member 110. The first bearing surface 412 may provide sufficient frictional force (against relative movement in the rotational directions) with the inner wall 480 of the outer tube member 110 such that the first frictional element 410 may rotate with the outer tube member 110 together about the longitudinal axis, relative to the inner tube member 120. No or insignificant amount of frictional force may be provided in the rotational directions given that the first frictional element 410 rotates with the outer tube member 110, and is rotatable relative to the inner tube member 120.

As shown in the non-limiting example illustrated by FIG. 4, a cross section of the first frictional element 410 may be circular. In other non-limiting examples, the cross section of the first frictional element 410 may be oval, rectangular, square, or of other suitable shapes. The groove 416 may be shaped according to the shape of the cross section of the first frictional element 410.

The groove 416 (and the first frictional element 410) may be located at any suitable location along the length of the inner tube member 120. In some embodiments, the groove 416 may be arranged at a bottom portion of the inner tube member 120. The bottom portion may be a portion of the inner tube member 120 closest to the base portion 140 (or the second joint 145). In particular embodiments, the groove 416 may be arranged at a bottom end of the inner tube member 120. The bottom end of the inner tube member 120 may be an end of the inner tube member 120 that is closest to the base portion 140 (or the second joint 145).

In other embodiments, the groove 416 may be arranged at a middle portion or a top portion of the inner tube member 120. The top portion of the inner tube member 120 may be an portion opposite to the bottom portion of the inner tube member 120. In other words, the top portion of the inner tube member 120 may be a portion of the inner tube member 120 that is closest to the head portion 130 (or the first joint 135).

As shown in the non-limiting example illustrated by FIG. 4, the groove 416 may be arranged to retain one first frictional element 410. In other non-limiting examples, the groove 416 may be arranged to retain two or more first frictional elements 410. In further embodiments, two or more grooves 416 may be arranged at one or more portions (e.g., the bottom portion, middle portion, and/or upper portion) of the inner tube member 120. Each of the two or more first frictional elements 410 in the groove 416 may be associated with a predetermined amount of frictional force between the first bearing surface 412 and the inner wall 480 of the outer tube member 110. Thus, an appropriate amount of frictional force may be calibrated by adding an appropriated number of first frictional elements 410. In particular embodiments, 1, 2, 3, or 4 first frictional elements 410 may be arranged in the groove 416. In other embodiments, 5 or more first frictional elements 410 may be arranged in the groove 416.

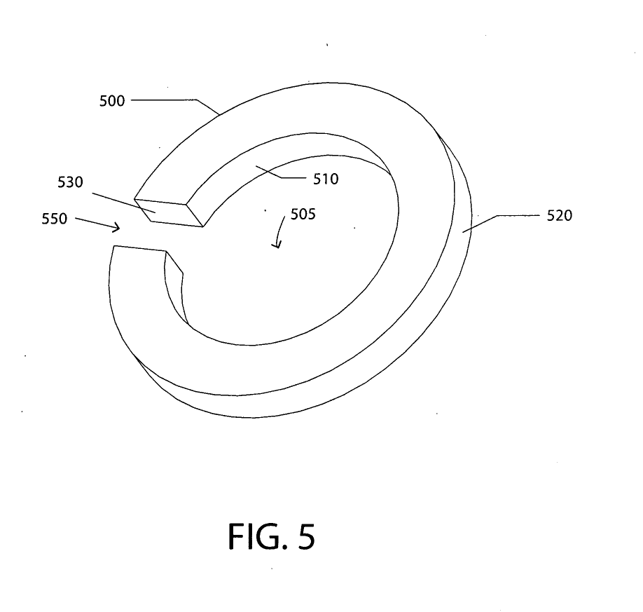

FIG. 5 is a perspective view of an embodiment of a first frictional element 500. Referring to FIGS. 1-5, the first frictional element 500 may be an alternative embodiment to the first frictional element 410. In some embodiments, the first frictional element 500 may be a partial annular component with a first opening 555. During the assembly or calibration process, the first frictional element 500 may be pushed to or pulled from the inner tube member 120 (at the groove, e.g., the groove 416) through the first opening 555. The first hole 505 defined by the body of the first frictional element 500 may be configured to provide a space for the inner tube member 120. In other embodiments, the first frictional element 500 may be a complete annular component without any opening.

The first frictional element 500 may have a rectangular cross section 530. The rectangular cross section 530 may allow two or more of the first frictional element 500 to be stacked together and fitted into a same groove (e.g., the groove 416) of the inner tube member 120, where a recess defined by the groove may be in the shape of a cube or cuboid. The first bearing surface 520 may be a bearing surface such as, but not limited to, the first bearing surface 412. For example, the first bearing surface 520 may be configured to contact the inner wall 480 of the outer tube member 110 to provide friction against movement in the telescopic directions between the inner wall 480 of the outer tube member 110 and the first bearing surface 520.

In some embodiments, an inner circumference (e.g., an inner diameter) defined by the first inner wall 510 of the first frictional element 500 may be greater than an outer circumference of the groove of the inner tube member 120. Therefore, insignificant or no portions of the first inner wall 510 may contact the walls of the groove of the inner tube member 120, resulting in insignificant or no friction in the rotational dimensions. In further embodiments, the first inner wall 510 may be composed of low-friction materials (e.g., low friction plastic or the like) to further reduce friction between the first inner wall 510 and the walls of the groove.

In some embodiments, an outer circumference (e.g., an outer diameter) defined by the first bearing surface 520 may be equal to an inner circumference (e.g., an inner diameter) defined by the inner wall 480 of the outer tube member 110. This allows a sufficiently tight fit between the first frictional element 500 and the outer tube member 110 to provide frictional forces against relative movement between those parts in the telescoping directions.

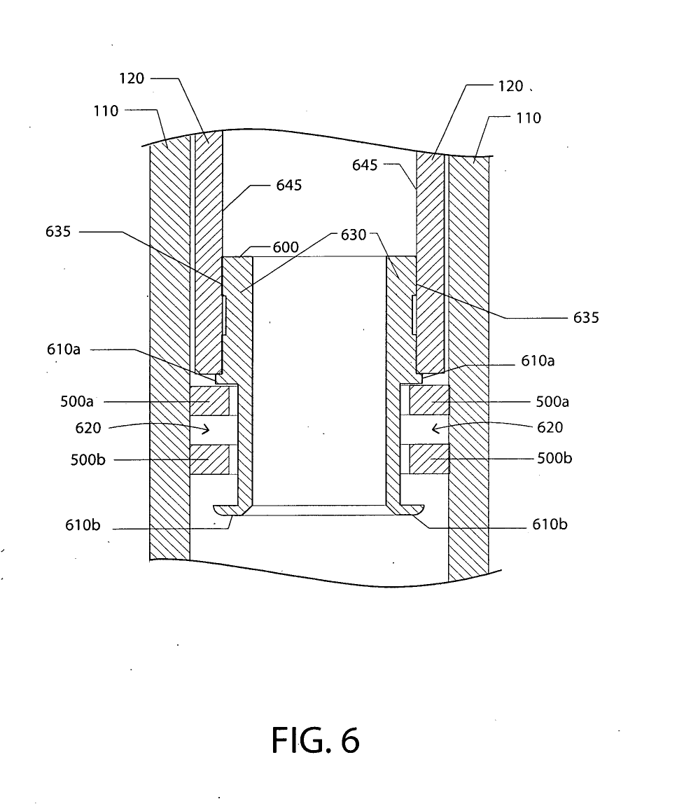

FIG. 6 is a cross-section view of an embodiment of a telescoping friction component 600 arranged in the adjustable structure 100 having the inner tube member 120 and the outer tube member 110. Referring to FIGS. 1-6, the telescoping friction component 600 may be a separate portion attached to an end portion of the inner tube member 120 in some embodiments. For example, an insert portion 630 of the telescoping friction component 600 may be inserted into an inner volume of the inner tube member 120. The insert portion 630 may include a fixing surface 635 for attaching the insert portion (as well as the entire telescoping friction component 600) to the inner wall 645 of the inner tube member 120. The fixing surface 635 and the inner wall 645 of the inner tube member 120 may be attached to one by one of more of: adhesive, welding, nails, screws, physical force, and the like. The telescoping friction component 600 may be configured to be detachable in some non-limiting examples. In other embodiments, the telescoping friction component 600 may be a portion that forms the end of the inner tube member 120.

The telescoping friction component 600 may be arranged at the bottom end of the inner tube member 120. Given that the inner tube member 120 may be movable in the telescoping directions while the outer tube member 110 may remain stationary in the telescoping directions, arranging the telescoping friction component 600 at the bottom end of the inner tube member 120 may avoid collision between the telescoping friction component 600 and other elements between the inner tube member 120 and the outer tube member 110, such as, but not limited to, at least one second frictional element 420.

A groove 620 may be defined by an upper protrusion 610a and a lower protrusion 610b. In some embodiments, both the upper protrusion 610a and the lower protrusion 610b may form from the body of the telescoping friction component 600. In particular, the bottom protrusion 610b may be flared once first frictional elements 500a, 500b are inserted into the groove 620. In other embodiments, at least one of the upper protrusion 610a and the lower protrusion 610b may be attached to the telescoping friction component 600 by one of more of: adhesive, welding, nails, screws, physical force, and the like.

The first frictional elements 500a, 500b may be arranged in the groove 620 around the inner tube member 120. In some embodiments, each of the first frictional elements 500a, 500b may be the first frictional element 500. The upper protrusion 610a and lower protrusion 610b may be stoppers to prevent the first frictional elements 500a, 500b from moving outside of the groove 620. Additional space in the groove 620 may be provided to accommodate additional first frictional elements (e.g., the first frictional elements 500a, 500b). The amount of frictional force against relative movement of the inner and outer tube members 120 and 110 in the telescoping direction is proportional to a number of first frictional elements in the groove 620. For example, the higher the number of first frictional elements in the groove 620, the larger a collective first bearing surface (e.g., one or more first bearing surfaces 520) may be to provide greater frictional force. Accordingly, the frictional force against relative movement of the inner and outer tube members 120 and 110 in the telescoping direction may be adjusted based on a number of the first frictional elements (e.g., the first frictional elements 500a, 500b) arranged in the groove 620.

Referring again to FIGS. 1-4, the second frictional element 420 may be configured to exert frictional force against relative movement of the inner and outer tube members 120 and 110 in the rotational directions. In particular, the second frictional element 420 may hold the structure of the adjustable structure 100 (e.g., the relative positions of the inner tube member 120 and the outer tube member 110) in place by providing a frictional force against relative movement of those parts in the rotational directions. In other words, the second frictional element 420 may provide an appropriate amount of frictional force against relative movement of the second frictional element 420 and the inner tube member 120, in the rotational directions, to prevent the inner tube member 120 from drooping due to gravity 190. The second frictional element 420 may be made of suitable material such as, but not limited to, metal, plastic, ceramic, wood, composite material, or the like.

In some embodiments, the second frictional element 420 may be a bushing (of any suitable shape, including an annular shape) around the inner tube member 120. In other embodiments, the second frictional element 420 may be a C-shaped or incomplete annular shaped member in the manner described. The second frictional element 420 may have a second bearing surface 422 contacting the inner wall 480 of the outer tube member 110. The second bearing surface 422 may provide a frictional force on the inner wall 480 of the outer tube member 110, against movement in the rotational direction (about the axis) of the inner tube member 120 with respect to the outer tube member 110.

In various embodiments, the second frictional element 420 may be rotationally fixed with respect to at least one of the outer tube member 110 or the inner tube member 120 in the rotational directions. In a non-limiting example, the second frictional element 420 may be rotationally fixed with respect to the inner tube member 120 and exert rotational friction against the outer tube member 110. In another non-limiting example, the second frictional element 420 may be rotationally fixed with respect to the outer tube member 110 and exert rotational friction against the inner tube member 120.

In some embodiments, the second frictional element 420 is moveable in the axial or telescoping directions along the length dimension of the inner tube member 120, the outer tube member 110, or both. In particular, the second frictional element 420 may exert insignificant or no frictional force on the inner wall 480 of the outer tube member 110 in the axial or telescoping directions, as it moves along the axial or telescoping directions (for example, when at least one of the inner tube member 120 or outer tube member 110 is moved in a telescoping direction relative to the other).

Stoppers (not shown) may be provided along the telescoping directions and between the inner tube member 120 and the outer tube member 110 to confine the movement of the second frictional element 420. For example, the second frictional element 420 may be confined to move between two stoppers. One stopper may be located at the upper portion of the inner tube member 120 and another stopper may be located at the bottom portion of the inner tube member 120. The stoppers may be attached to the inner tube member 120 and/or the outer tube member 110 by one of more of: adhesive, welding, nails, screws, physical force, and the like. Alternatively, the stoppers may form from the inner tube member 120 and/or the outer tube member 110.

As shown in the non-limiting example illustrated by FIG. 4, a cross section of the second frictional element 420 may be rectangular. In other non-limiting examples, the cross section of the first frictional element 410 may be oval, circular, square, or of other suitable shapes.

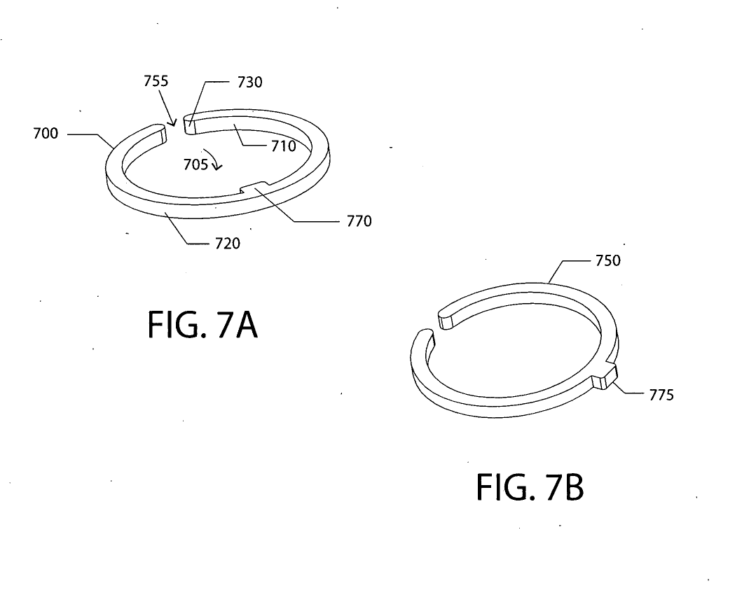

FIG. 7A is a perspective view of an embodiment of a second frictional element 700. Referring to FIGS. 1-7A, the second frictional element 700 may be an embodiment of the second frictional element 420. In some embodiments, the second frictional element 700 may be an annular (or partially annular) component with a second opening 755. During the assembly or calibration process, the second frictional element 700 may be pushed to or pulled from the inner tube member 120 through the second opening 755. A second hole 705 defined by a body of the second frictional element 700 may be configured to provide a space for the inner tube member 120. In other embodiments, the second frictional element 700 may be a complete annular component without any opening.

The second frictional element 700 may have a rectangular cross section 730. The rectangular cross section 730 may allow two or more of the first frictional element 700 to be stacked together along the telescoping directions of the inner tube member 120. A second bearing surface 720 may be a bearing surface such as, but not limited to, the second bearing surface 422. For example, the second bearing surface 720 may be configured to contact the inner walls 480 of the outer tube member 110 to provide friction against motion in the rotational directions between the inner walls 480 of the outer tube member 110 and the second bearing surface 720.

In some embodiments, an inner circumference (e.g., an inner diameter) defined by the second inner wall 710 of the second frictional element 700 may be greater than an outer circumference of the inner tube member 120. Therefore, the second frictional element 700 may freely move along the axial or telescoping directions subject to confines of the stoppers. In further embodiments, the second inner wall 710 may be composed of low-friction materials (e.g., low friction plastic or the like) to further reduce friction between the second inner wall 710 and the walls of the inner tube member 120.

In some embodiments, an outer circumference (e.g., an outer diameter) defined by the second bearing surface 720 may be equal to an inner circumference (e.g., an inner diameter) defined by the inner wall of the outer tube member 110. This allows a sufficiently tight fit between the second frictional element 700 and the outer tube member 110 to provide frictional forces against relative movement of those parts in the rotational directions.

In some embodiments, when a force in the clockwise direction 170 or the counterclockwise direction 175 is felt by the second frictional element 700, the second frictional element 700 may bend or otherwise deformed, by virtue of the second opening 755, along the telescoping directions. The second frictional element 700 may be composed of flexible material such as, but not limited to, flexible plastic. As such, the tension of the second frictional element 700 from the bending may provide additional frictional forces against relative movement in the rotational directions compared to embodiments where the second frictional element 700 does not bend (e.g., in embodiments where the second frictional element 700 is a complete, rigid annular member without the second opening 755).

In other embodiments, the shape of the second frictional element 700 may inhibit the second frictional element 700 from moving when a force in the clockwise direction 170 or the counterclockwise direction 175 is felt by the second frictional element 700. In one non-limiting example, the second inner wall 710 may define a geometric shape (e.g., oval) corresponding a cross-section shape (e.g., an oval of the same size) of the inner tube member 120 such that movement of the second frictional element 700 with respect to the inner tube member 120 may be prohibited in the rotational directions. In another non-limiting example, the second bearing surface 720 may define a geometric shape (e.g., oval) corresponding a cross-section shape (e.g., an oval of the same size) of the outer tube member 110 such that movement of the second frictional element 700 with respect to the outer tube member 110 may be prohibited in the rotational directions.

The second frictional element 700 may also include a tab 770. The tab 770 may fit into a channel on the inner tube member described herein. The dimension of the tab 770 may be less than the dimension of the space created by the channel to allow the second frictional element 700 to move in the telescoping directions along the channel with minimal or no contact with edges of the channel. When a force in the rotational direction is imparted on the second frictional element 700, the tab 770, being in the channel of the inner tube member 120, may prevent the second frictional element 700 from moving in the rotational direction relative to the inner tube member 120, allowing the second bearing surface 720 to exert frictional force on the inner surface of the outer tube member 110 to against movement in the rotational directions.

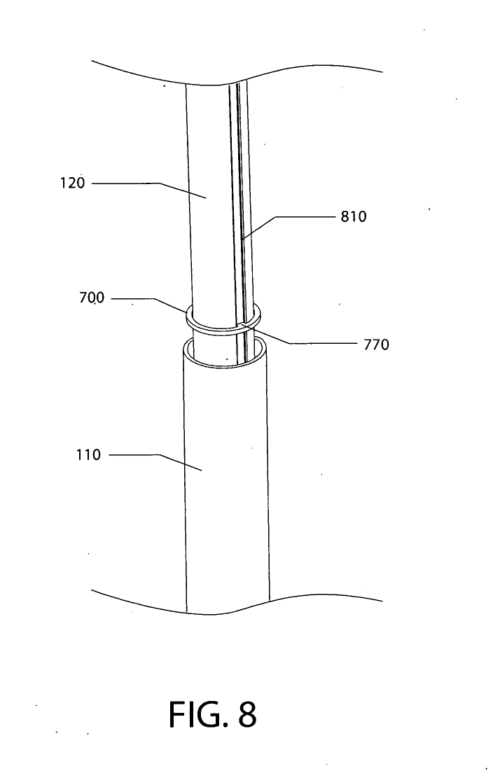

FIG. 7B is a perspective view of another embodiment of a second frictional element 750. Referring to FIGS. 1-7B, the second frictional element 750 may be an element such as, but not limited to, the second frictional element 700, except the outward-protruding tab 775. The outward-protruding tab 775 may be an alternative embodiment to the tab 770. For example, the outward-protruding tab 775 may protrude from the second bearing surface 720 toward the inner wall of the outer tube member 110 (in an opposite direction of protrusion as compared to the tab 770). The inner wall of the outer tube member may include a channel such as a channel 810 (of FIG. 8) to receive the tab 770 and inhibit rotational movement of the second frictional element 750 (while allowing linear, axial movement of the second frictional element 750) relative to the inner tube member 120. The outward-protruding tab 775 may include two or more outward-protruding tabs 775 spaced around the bearing surface 720. Each of the two or more outward-protruding tabs 775 may protrude into a channel of the inner walls of the outer tube member 110.

FIG. 8 is a perspective view of an embodiment of the second frictional element 700 arranged in the adjustable structure 100 having the inner tube member 120 and the outer tube member 110. Referring to FIGS. 1-8, the inner tube member 120 may have a channel 810 extending linearly along the axial or telescoping directions. The channel 810 may extend from the upper portion (e.g., upper end) of the inner tube member 120 to the bottom portion (e.g., bottom end) along a longitudinal dimension (e.g., telescoping directions) of the inner tube member 120. The tab 770 may be arranged inside of the channel 810 when the second frictional element 700 is arranged around the inner tube member 120. The walls of the channel 810 may block the second frictional element 700 (by blocking the tab 770) from moving in the rotational directions relative to the inner tube member 120, while allowing the second frictional element 700 to be moved in the axial or telescoping direction relative to the inner tube member 120. The tab 770 may include two or more tabs 770 spaced around the second inner wall 710. Each of the two or more tabs 770 may protrude into one of a plurality of channels, each of which may be a channel such as, but not limited to, the channel 810.

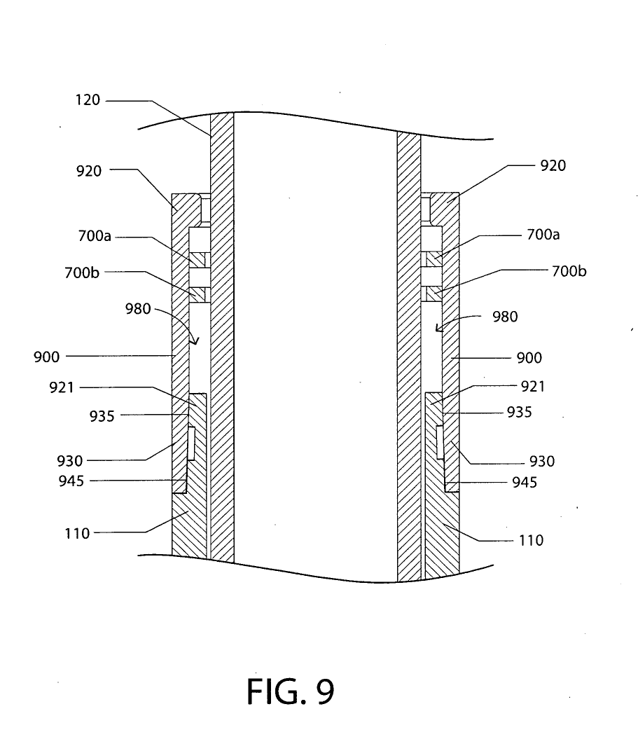

FIG. 9 is a cross-section view of an embodiment of a rotational friction component 900 arranged in the adjustable structure 100 having the inner tube member 120 and the outer tube member 110. Referring to FIGS. 1-9, the rotational friction component 900 may be a separate portion attached to an end of the outer tube member 110 in some embodiments. For example, an attached portion 930 of the rotational friction component 900 may be attached to an outer wall 945 of the outer tube member 110. The attached portion 930 may include a fixing surface 935 for attaching the attached portion 930 (as well as the entire rotational friction component 900) to the outer wall 945 of the outer tube member 110. The fixing surface 935 and the outer wall 945 of the outer tube member 110 may be attached to one by one of more of: adhesive, welding, nails, screws, physical force, and the like. The rotational friction component 900 may be configured to be detachable in some non-limiting examples. In other embodiments, the rotational friction component 900 may be a portion that forms from the end of the outer tube member 110.

The rotational friction component 900 may be arranged at the upper end of the outer tube member 110. The upper end of the outer tube member 110 may be an end of the outer tube member 110 that is closest to the head portion 130 (the first joint 135). Given that the telescoping friction component 600 may be arranged at the bottom end of the inner tube member 120 and the rotational friction component 900 may be arranged at the upper end of the outer tube member 110, collision between the telescoping friction component 600 and the rotational friction component 900 (both between the inner tube member 120 and the outer tube member 110) can be avoided.

Stoppers 920, 921 may be provided to restrict the movement of second frictional elements 700a, 700b. For example, the first stopper 920 may be arranged at an end of the rotational friction component 900. The second stopper 921 may be arranged at an end of the outer tube member 110. One of ordinary skill in the art would appreciate that each of the stoppers 920, 921 may be arranged at any suitable location including along the telescoping directions on the rotational friction component 900, the outer tube member 110, or the inner tube member 120. The stoppers 920, 921 may be attached to the inner tube member 120 and/or the outer tube member 110 by one of more of: adhesive, welding, nails, screws, physical force, and the like. Alternatively, the stoppers 920, 921 may form from the inner tube member 120 and/or the outer tube member 110.

The second frictional elements 700a, 700b may be arranged in the volume 980 defined by the stoppers 920, 921. In some embodiments, each of the second frictional elements 700a, 700b may be the second frictional element 700. Additional space in the volume 980 may be provided to accommodate additional second frictional elements. The amount of frictional force against relative movement of the inner and outer tube members 120 and 110 in the rotational direction is proportional to a number of second frictional elements in the volume 980. For example, the higher the number of the second frictional elements in the volume 980, the larger a collective second bearing surface (e.g., one or more second bearing surfaces 720) may be to provide greater frictional force. Accordingly, the frictional force against relative movement of the inner and outer tube members 120 and 110 in the rotational direction may be adjusted based on a number of the second frictional elements (e.g., the second frictional elements 700a, 700b) arranged in the volume 980.

In some embodiments, the volume 980 may be configured to expand or contract based on the relative positions of the outer tube member 110 and the inner tube member 120. For example, when the inner tube member 120 reaches the furthest point in the outward telescoping direction 160, the volume 980 may be retracted to a least amount. On the other hand, when the inner tube member 120 reaches the furthest point in the inward telescoping direction 165, the volume 980 may be expanded to a most amount.

In some embodiments, the rotational friction component 900 (with the one or more second frictional elements 700a, 700b) and the telescoping friction component 600 (with the one or more first frictional elements 500a, 500b) may be arranged on a same end of the outer tube member 110, inner tube member 120, or both. The rotational friction component 900 and the telescoping friction component 600 may be a same component. The rotational friction component 900 and the telescoping friction component 600 may be adjacent or next to one another. In other embodiments, the rotational friction component 900 and the telescoping friction component 600 may be arranged on different ends of the outer tube member 110 and/or the inner tube member 120. The rotational friction component 900 and the telescoping friction component 600 may be separate components that are not adjacent to one another.

Embodiments described herein relate to the first frictional element and the second frictional element implemented for a telescoping arm of the adjustable structure 100 (e.g., an adjustable lamp). However, in other embodiments, the first frictional element and the second frictional element may be configured for supplying friction for other members in other devices or systems, such as, but not limited to connecting one or more tools, weapons, work-pieces or other implementation to a support arm or other members, or providing friction support for two members that contact one another.

Embodiments described herein relate to the inner tube member 120 being movable in the telescoping directions and/or rotational directions (by manual operation of a user) with respect to the outer tube member 110, which may be fixed with respect to the telescoping directions and/or rotational directions. One of ordinary skill in the art would appreciate that similar embodiments may be applicable to systems where 1) the outer tube member 110 is movable in the telescoping directions and/or rotational directions (by user movement) with respect to the inner tube member 120, which may be fixed with respect to the telescoping directions and/or rotational directions, or 2) both the outer tube member 110 and the inner tube member 120 may be manually movable with respect to the telescoping directions and/or rotational directions.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown, in sequential order or that all illustrated operations be performed to achieve desirable results. In certain circumstances, multitasking and parallel processing may be advantageous. Moreover, the separation of various system components in the implementations described above should not be understood as requiring such separation in all implementations and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking or parallel processing may be utilized.

What is claimed is:

1. An adjustable structure, comprising:
an inner tube member;
an outer tube member, wherein the inner tube member and the outer tube member are configured to move in at least one of a telescoping direction or a rotation direction with respect to one another;
a first frictional element between the inner tube member and the outer tube member, the first frictional element providing friction against relative movement of the he inner tube member and the outer tube member telescoping direction; and
a second frictional element between the inner tube member and the outer tube member, the second frictional element providing friction against relative movement of the he inner tube member and the outer tube member in the rotational direction.

2. The adjustable structure of claim 1, wherein the first frictional element and the second frictional element are separate components.

3. The adjustable structure of claim 1, wherein the first frictional element and the second frictional element are a same component.

4. The adjustable structure of claim 1, wherein the first frictional element remains stationary in the telescoping direction with respect to the inner tube member.

5. The adjustable structure of claim 1, wherein the second frictional element remains stationary in the rotational direction with respect to the inner tube member.

6. The adjustable structure of claim 1, wherein the first frictional element is frictionless with respect to at least one of the outer tube member or the inner tube member in the rotational direction.

7. The adjustable structure of claim 1, wherein the second frictional element is frictionless with respect to at least one of the outer tube member or the inner tube member in the telescoping direction.

8. The adjustable structure of claim 1, wherein frictional force exerted to the inner tube member and the outer tube member by the first frictional element and the second frictional element are independently adjustable.

9. The adjustable structure of claim 8, wherein the frictional force provided to the inner tube member and the outer tube member in the telescoping direction is adjusted by adjusting a number of first frictional element.

10. The adjustable structure of claim 8, wherein the frictional force provided to the inner tube member and the outer tube member in the rotational direction is adjusted by adjusting a number of second frictional element.

11. The adjustable structure of claim 1, the adjustable structure further comprises a base portion, wherein:
the outer tube member is fixed to the base portion;
the inner tube member comprises a bottom end, the bottom end being the end of the inner tube member that is closest to the base portion;
the first frictional element is arranged at the bottom end of the inner tube member.

12. The adjustable structure of claim 1, the second frictional element is configured to move in the telescoping direction along a length of at least one of the inner tube member or outer tube member.

13. A first friction component arranged between an inner tube member and an outer tube member, the first friction component comprising:
at least one first frictional element, each of the at least one first frictional element comprises:
an annular body;
an inner surface, wherein an inner diameter defined by the inner surface is greater than a diameter of the inner tube member;
a bearing surface arranged to contact an inner wall of the outer tube member; and
a groove configured to contain the at least one frictional element.

14. The first friction component of claim 13, wherein an outer diameter defined by the bearing surface is equal to a diameter of the inner wall of the outer tube member.

15. The first friction component of claim 13, wherein the groove is provided at an end of the inner tube member.

16. The first friction component of claim 13, wherein the at least one frictional element comprises two or more frictional elements.

17. A second friction component arranged between an inner tube member and an outer tube member, the second friction component comprising:
at least one second frictional element, each of the at least one second frictional element comprises:
an annular body;
an inner surface, wherein an inner diameter defined by the inner surface is greater than a diameter of the inner tube member;
a bearing surface arranged to contact an inner wall of the outer tube member; and
a tab configured to engage a channel of the inner tube member, the channel being arranged along a longitudinal dimension of the inner tube member.

18. The second friction component of claim 17, wherein an outer diameter defined by the bearing surface is equal to a diameter of the inner wall of the outer tube member.

19. The second friction component of claim 17, wherein the tab is configured to inhibit rotational movement of the second frictional element with respect to the inner tube member.

20. The second friction component of claim 17, wherein:
the annular body comprises an opening, and
the second frictional element is configured to bend when a rotational force is applied by the outer tube member.
